(19) United States
(12) Patent Application Publication
(10) Pub. No.: US 2013/0162602 A1
(43) Pub. Date: Jun. 27, 2013

(54) DISPLAY DEVICE WITH OPTICAL SENSOR

(71) Applicants: Yousuke Nakagawa, Osaka-shi (JP); Kazuhiro Maeda, Osaka-shi (JP); Sachio Tsujino, Osaka-shi (JP); Hiroaki Sugiyama, Osaka-shi (JP); Ichiroh Shiraki, Osaka-shi (JP)

(72) Inventors: Yousuke Nakagawa, Osaka-shi (JP); Kazuhiro Maeda, Osaka-shi (JP); Sachio Tsujino, Osaka-shi (JP); Hiroaki Sugiyama, Osaka-shi (JP); Ichiroh Shiraki, Osaka-shi (JP)

(21) Appl. No.: 13/810,214

(22) PCT Filed: Apr. 25, 2011
(86) PCT No.: PCT/JP2011/060053

§ 371 Date: Jan. 15, 2013

(30) Foreign Application Priority Data
Jul. 16, 2010 (JP) 2010-161979

(51) Int. Cl. G06F 3/042

(52) U.S. Cl. CPC G06F 3/042
USPC 345/175

(57) ABSTRACT

A plurality of sensor circuits each including an optical sensor and a charge retention transistor each provided between a reset line and an accumulation node are arranged in a pixel region of a display device. In a sensing period, a LOW-level voltage is applied as a reset cancellation voltage to the reset line RSTa, and a HIGH-level voltage is applied to a control line CLKa to control the charge retention transistor to be in an ON state. In a period other than the sensing period, the LOW-level voltage is applied to the control line CLKa to control the charge retention transistor to be in an OFF state, and the HIGH-level voltage is applied as a retention voltage to the reset line RSTa. Thus, a drain-source voltage Vds of the charge retention transistor is lowered, a leakage current through the charge retention transistor is reduced, and a light detection accuracy is enhanced. A substantially middle voltage between a reset voltage and a voltage at an accumulation node at the sensing of a maximum amount of light may be used as the retention voltage.

### TECHNICAL FIELD

The present invention relates to display devices, more particularly, a display device in which a plurality of optical sensors are arranged in a pixel region.

### BACKGROUND ART

With regard to display devices, heretofore, there have been known methods of providing input functions such as a touch panel, pen input and a scanner in such a manner that a plurality of optical sensors are provided on a display panel. In order to adapt such a method to a mobile appliance to be used under various light environments, it is necessary to eliminate an influence of the light environment. Hence, there has also been known a method of removing a component which undergoes an influence of a light environment, from a signal sensed by an optical sensor to obtain a signal to be input intrinsically.

As one of these methods, there has been known a backlight difference method shown in FIG. 16. As shown in the left side of FIG. 16, in a case where an optical sensor senses light reflected from a target (e.g., a finger) in the vicinity of a surface of a display panel, with a backlight light used as signal light, the optical sensor senses both the signal light and environmental light. Hence, in the backlight difference method, the sensing is performed in a state that the backlight is turned on and in a state that the backlight is turned off. The signal light and the environmental light are sensed by the sensing when the backlight is turned on, and the environmental light is sensed by the sensing when the backlight is turned off. Accordingly, it is possible to extract only the signal light by obtaining a difference between the two results of sensing. According to the backlight difference method, it is possible to provide an input function which does not depend on a light environment.

When the optical sensor is made to operate, it is necessary to perform reset and read on the sensor circuit. Moreover, as a method of sensing only light incident in a predetermined period, there is a method of providing a transistor (hereinafter, referred to as a charge retention transistor) in series with the optical sensor, and performing ON/OFF control on the charge retention transistor. There are wide variations as for the timing of performing the reset and the read on the sensor circuit and the timing of performing the ON/OFF control on the charge retention transistor.

In association with the invention of this application, Patent Document 1 discloses a liquid crystal device provided with a sensor part including a photoelectric converting element, a capacitive element, and a switching element provided between a reset line and the capacitive element, wherein a reference light-reception signal is read in a state that a reset signal is asserted, and a measurement light-reception signal is read after a lapse of a predetermined time from the negation of the reset signal.

### PRIOR ART DOCUMENT

### Patent Document

[Patent Document 1] Japanese Laid-Open Patent Publication No. 2009-36946

### SUMMARY OF THE INVENTION

### Problems to be Solved by the Invention

In a sensor circuit, a charge retention transistor is provided in series with an optical sensor between a reset terminal and an accumulation node (see FIG. 3 to be described later). The charge retention transistor is controlled to be in an ON state in a sensing period, and is controlled to be in an OFF state in a retention period in which a result of sensing is retained. However, even when the charge retention transistor is controlled to be in the OFF state in the retention period, a leakage current flows through the charge retention transistor and, therefore, an amount of charges accumulated in the accumulation node changes. Therefore, a display device provided with the sensor circuit including the charge retention transistor has a problem in that noise is mixed into an output from the sensor circuit, which leads to degradation in light detection accuracy.

This problem becomes conspicuous in a case where light is not incident on the optical sensor in the sensing period, but intense light is incident on the optical sensor in the retention period, for example. To be exact, the output from the sensor circuit will become zero in this case. However, when the leakage current flows through the charge retention transistor, the output from the sensor circuit does not become zero. Moreover, this problem becomes conspicuous also in a case where the length of the retention period differs for each sensor circuit (refer to the description of FIG. 7 to be given later).

Hence, an object of the present invention is to provide a display device that reduces a leakage current flowing through a charge retention transistor and has a high light detection accuracy.

### Means for Solving the Problems

According to a first aspect of the present invention, there is provided a display device in which a plurality of optical sensors are arranged in a pixel region, the display device including: a display panel including a plurality of pixel circuits and a plurality of sensor circuits; and a drive circuit driving the pixel circuit and the sensor circuit, wherein the sensor circuit includes: an accumulation node accumulating a charge corresponding to an amount of sensed light; an optical sensor provided between the accumulation node and a reset line to be controlled by the drive circuit; and a charge retention transistor provided in series with the optical sensor and subjected to ON/OFF control by the drive circuit, and the drive circuit applies, to the reset line, a retention voltage for lowering a voltage between conductive terminals of the charge retention transistor, during a period that the charge retention transistor is controlled to be in an OFF state.

According to a second aspect of the present invention, in the first aspect of the present invention, the drive circuit applies a reset voltage as the retention voltage to the reset line.

According to a third aspect of the present invention, in the first aspect of the present invention, the drive circuit applies a voltage between a reset voltage and a reset cancellation voltage, as the retention voltage to the reset line.

According to a fourth aspect of the present invention, in the third aspect of the present invention, the drive circuit applies a substantially middle voltage between the reset voltage and a voltage at the accumulation node at the sensing of a maximum amount of light, as the retention voltage to the reset line.

According to a fifth aspect of the present invention, in the first aspect of the present invention, the display device further includes: a light source to be turned on and off at a predetermined cycle, wherein the sensor circuits include a first sensor circuit and a second sensor circuit, and the drive circuit controls the charge retention transistor in the first sensor circuit to be in an ON state during a period that light source is turned off, and controls the charge retention transistor in the second sensor circuit to be in the ON state during a period that the light source is turned on.

According to a sixth aspect of the present invention, in the fifth aspect of the present invention, the drive circuit performs read from the first and second sensor circuits in a line sequential manner while controlling all the charge retention transistors in the first and second sensor circuits to be in an OFF state.

According to a seventh aspect of the present invention, in the sixth aspect of the present invention, the drive circuit performs the read from the first sensor circuit and the read from the second sensor circuit in parallel.

According to an eighth aspect of the present invention, in the first aspect of the present invention, one end of the optical sensor is connected to the reset line, the other end is connected to one of the conductive terminals of the charge retention transistor, and the other conductive terminal of the charge retention transistor is connected to the accumulation node.

According to a ninth aspect of the present invention, in the eighth aspect of the present invention, the sensor circuit further includes a read transistor having a control terminal connected to the accumulation node.

According to a tenth aspect of the present invention, in the ninth aspect of the present invention, the sensor circuit further includes a capacitor provided between the accumulation node and a read line to be controlled by the drive circuit.

### Effects of the Invention

According to the first aspect of the present invention, it is possible to lower the voltage between the conductive terminals of the charge retention transistor, and to reduce the leakage current flowing through the charge retention transistor, by applying the retention voltage to the reset line in the retention period. Accordingly, it is possible to restrain the voltage at the accumulation node from changing in the retention period, and to enhance a light detection accuracy.

According to the second aspect of the present invention, by using the reset voltage as the retention voltage, it is possible to lower the voltage between the conductive terminals of the charge retention transistor, and to reduce the leakage current flowing through the charge retention transistor, without generating a new voltage. Accordingly, it is possible to enhance the light detection accuracy with simple circuitry.

According to the third aspect of the present invention, by using, as the retention voltage, the suitable voltage between the reset voltage and the reset cancellation voltage, it is possible to further lower the voltage between the conductive terminals of the charge retention transistor, and to further reduce the leakage current flowing through the charge retention transistor. Accordingly, it is possible to further enhance the light detection accuracy by using the suitable voltage.

According to the fourth aspect of the present invention, by using, as the retention voltage, the substantially middle voltage between the reset voltage and the voltage at the accumulation node at the sensing of the maximum amount of light, it is possible to further lower the voltage between the conductive terminals of the charge retention transistor, and to further reduce the leakage current flowing through the charge retention transistor. Accordingly, it is possible to further enhance the light detection accuracy by using the suitable voltage.

According to the fifth aspect of the present invention, it is possible to individually sense the amount of light when the light source is turned off and the amount of light when the light source is turned on, by using the two types of sensor circuits, and to obtain the difference between the two amounts at the outside of the sensor circuit. Accordingly, it is possible to provide an input function which does not depend on a light environment, by using light emitted from the light source as signal light.

According to the sixth aspect of the present invention, it is possible to increase the degree of freedom at the determination of the sensing and read timings by performing the sensing by the sensor circuit and the read by the sensor circuit in the different periods.

According to the seventh aspect of the present invention, it is possible to make a read speed slower, and to reduce a power consumption of the display device, by performing the read from the first sensor circuit and the read from the second sensor circuit in parallel.

According to the eighth aspect of the present invention, it is possible to constitute the sensor circuit that senses only the light incident in the predetermined period, by connecting the optical sensor and the charge retention transistor in series, connecting one end thereof to the reset line, and connecting the other end to the accumulation node.

According to the ninth aspect of the present invention, it is possible to output the signal corresponding to the voltage at the accumulation node from one of the conductive terminals of the read transistor, and to read the signal corresponding to the amount of sensed light from the sensor circuit, by providing the read transistor in the sensor circuit, and applying the predetermined voltage to the other conductive terminal of the read transistor.

According to the tenth aspect of the present invention, it is possible to change the voltage at the accumulation node, and to read the signal corresponding to the amount of sensed light from the sensor circuit, by providing the capacitor in the sensor circuit, and applying the read voltage to the read line.

### BRIEF DESCRIPTION OF THE DRAWINGS

FIG. 1 is a block diagram showing a configuration of a display device according to a first embodiment of the present invention.

FIG. 2 is a diagram showing an arrangement of sensor circuits and a configuration of a sensor row driver circuit, in the display device shown in FIG. 1.

FIG. 3 is a circuit diagram of the sensor circuit included in a display circuit shown in FIG. 1.

FIG. 4 is a diagram showing turn-on and turn-off timings of a backlight as well as reset and read timings for the sensor circuit, in the display device shown in FIG. 1.

FIG. 5 is a signal waveform diagram of a display panel in the display device shown in FIG. 1.

FIG. 6 is a signal waveform diagram of a first sensor circuit in the display device shown in FIG. 1.

FIG. 7 is a signal waveform diagram of the display panel in the display device according to a reference example.

FIG. 8 is a signal waveform diagram of the first sensor circuit in the display device according to the reference example.

FIG. 9 is a diagram showing an I-V characteristic of a photodiode.

FIG. 10 is a diagram showing an arrangement of sensor circuits and a configuration of a sensor row driver circuit, in a display device according to a second embodiment of the present invention.

FIG. 11 is a circuit diagram of a reset control circuit included in the sensor row driver circuit shown in FIG. 10.

FIG. 12 is a signal waveform diagram of a display panel in the display device according to the second embodiment of the present invention.

FIG. 13 is a signal waveform diagram of a first sensor circuit in the display device according to the second embodiment of the present invention.

FIG. 14A is a diagram showing an arrangement (a first example) of the sensor circuits in the display device according to a modification example of the present invention.

FIG. 14B is a diagram showing an arrangement (a second example) of the sensor circuits in the display device according to a modification example of the present invention.

FIG. 14C is a diagram showing an arrangement (a third example) of the sensor circuits in the display device according to a modification example of the present invention.

FIG. 15 is a circuit diagram of the sensor circuit included in the display circuit according to a modification example of the present invention.

FIG. 16 is a diagram showing a principle of a backlight difference method.

### MODES FOR CARRYING OUT THE INVENTION

### First Embodiment

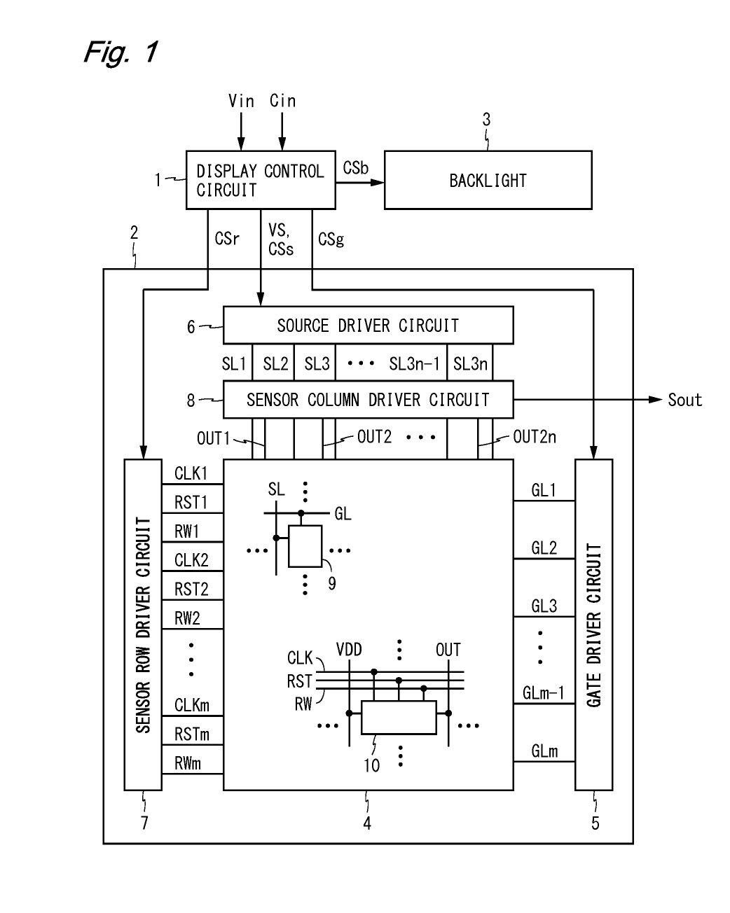

FIG. 1 is a block diagram showing a configuration of a display device according to a first embodiment of the present invention. The display device shown in FIG. 1 includes a display control circuit 1, a display panel 2 and a backlight 3. The display panel 2 includes a pixel region 4, a gate driver circuit 5, a source driver circuit 6, a sensor row driver circuit 7 and a sensor column driver circuit 8. The pixel region 4 includes a plurality of pixel circuits 9 and a plurality of sensor circuits 10. This display device has a function of displaying an image on the display panel 2, and a function of sensing light incident on the display panel 2. In the following definition, m and n each represent an even number, i represents an even number not greater than m, j represents an even number not greater than 2n, and a frame rate of the display device is 60 frames per second.

To the display device shown in FIG. 1, a video signal Vin and a timing control signal Cin are supplied from the outside. Based on these signals, the display control circuit 1 outputs a video signal VS and control signals CSg, CSs and CSr to the display panel 2, and outputs a control signal CSb to the backlight 3. The video signal VS may be equal to the video signal Vin, or may be a signal corresponding to the video signal Vin subjected to signal processing.

The backlight 3 is a light source for irradiating light to the display panel 2. More specifically, the backlight 3 is provided on a back side of the display panel 2, and irradiates light to the back of the display panel 2. The backlight 3 is turned on when the control signal CSb is in a HIGH level, and is turned off when the control signal CSb is in a LOW level. The backlight 3 is configured with an infrared LED (Light Emitting Diode) emitting infrared light, for example.

In the pixel region 4 of the display panel 2, (m×3n) pixel circuits 9 and (m×n) sensor circuits 10 are arranged in a two-dimensional manner, respectively. More specifically, m gate lines GL1 to GLm and 3n source lines SL1 to SL3n are formed in the pixel region 4. The gate lines GL1 to GLm are arranged in parallel to one another, and the source lines SL1 to SL3n are arranged in parallel to one another so as to be orthogonal to the gate lines GL1 to GLm. The (m×3n) pixel circuits 9 are arranged near intersections between the gate lines GL1 to GLm and the source lines SL1 to SL3n. Each of the pixel circuits 9 is connected to one gate line GL and one source line SL. The pixel circuits 9 are classified into those for red display, those for green display and those for blue display. These three types of pixel circuits 9 are arranged and aligned in an extending direction of the gate lines GL1 to GLm to form one color pixel.

In the pixel region 4, m control lines CLK1 to CLKm, m reset lines RST1 to RSTm and m read lines RW1 to RWm are formed in parallel to the gate lines GL1 to GLm. In the pixel region 4, moreover, 2n output lines OUT1 to OUT2n are formed in parallel to the source lines SL1 to SL3n. In the pixel region 4, further, a power supply line VDD, to which a predetermined power supply voltage is fixedly applied, is formed. The (m×n) sensor circuits 10 are arranged near intersections between the odd-numbered read lines RW1, RW3, . . . and the odd-numbered output lines OUT1, OUT3, . . . , and are arranged near intersections between the even-numbered read lines RW2, RW4, . . . and the even-numbered output lines OUT2, OUT4, . . . . Each of the sensor circuits 10 is connected to one control line CLK, one reset line RST, one read line RW, one output line OUT and the power supply line VDD.

The gate driver circuit 5, the source driver circuit 6, the sensor row driver circuit 7 and the sensor column driver circuit 8 function as a drive circuit driving the pixel circuit 9 and the sensor circuit 10. The gate driver circuit 5 is arranged along one side (the right side in FIG. 1) of the pixel region 4. The sensor row driver circuit 7 is arranged along the opposed side (the left side in FIG. 1) of the pixel region 4. The source driver circuit 6 and the sensor column driver circuit 8 are arranged along the different side (the top side in FIG. 1) of the display region. These drive circuits may be formed in a monolithic manner on the display panel 2 in conjunction with the pixel circuit 9 and the sensor circuit 10, or may be incorporated in an IC chip mounted on the display panel 2.

The gate driver circuit 5 drives the gate lines GL1 to GLm based on the control signal CSg. More specifically, based on the control signal CSg, the gate driver circuit 5 sequentially selects one gate line from the gate lines GL1 to GLm, applies a HIGH-level voltage to the selected gate line, and applies a LOW-level voltage to the remaining gate lines. Thus, the 3n pixel circuits 9 connected to the selected gate line are selected collectively.

The source driver circuit 6 drives the source lines SL1 to SL3n based on the control signal CSs. More specifically, based on the control signal CSs, the source driver circuit 6 applies voltages corresponding to the video signal VS to the source lines SL1 to SL3n. Herein, the source driver circuit 6 may perform line sequential driving or may perform dot sequential driving. The voltages applied to the source lines SL1 to SL3n are written into the 3n pixel circuits 9 selected by the gate driver circuit 5. As described above, the voltages corresponding to the video signal VS are written into all the pixel circuits 9 by using the gate driver circuit 5 and the source driver circuit 6, so that a desired image can be displayed on the display panel 2.

The sensor row driver circuit 7 drives the control lines CLK1 to CLKm, the reset lines RST1 to RSTm and the read lines RW1 to RWm based on the control signal CSr (the details thereof will be described later). Based on the control signal CSr, the sensor row driver circuit 7 applies the HIGH-level voltage to the even-numbered control lines while applying the LOW-level voltage to the even-numbered reset lines in a first sensing period. Next, the sensor row driver circuit 7 applies the HIGH-level voltage to the odd-numbered control lines while applying the LOW-level voltage to the odd-numbered reset lines in a second sensing period. The sensor circuit 10 senses light incident when the LOW-level voltage is applied to the reset line RST and the HIGH-level voltage is applied to the control line CLK. Thereafter, based on the control signal CSr, the sensor row driver circuit 7 sequentially selects adjacent two read lines from the read lines RW1 to RWm, and applies the HIGH-level voltage to the selected read lines. Thus, 2n signals are output from the 2n sensor circuits 10 connected to the selected read lines to the output lines OUT1 to OUT2n.

The sensor column driver circuit 8 includes a difference circuit (not shown) obtaining a difference between the output signal from the sensor circuit 10 in the odd-numbered row and the output signal from the sensor circuit 10 in the even-numbered row. The sensor column driver circuit 8 amplifies the signal difference obtained by the difference circuit, and outputs the amplified signal as a sensor output Sout to the outside of the display panel 2. As described above, by reading the signals from all the sensor circuits 10 by using the sensor row driver circuit 7 and the sensor column driver circuit 8, it is possible to sense the light incident on the display panel 2.

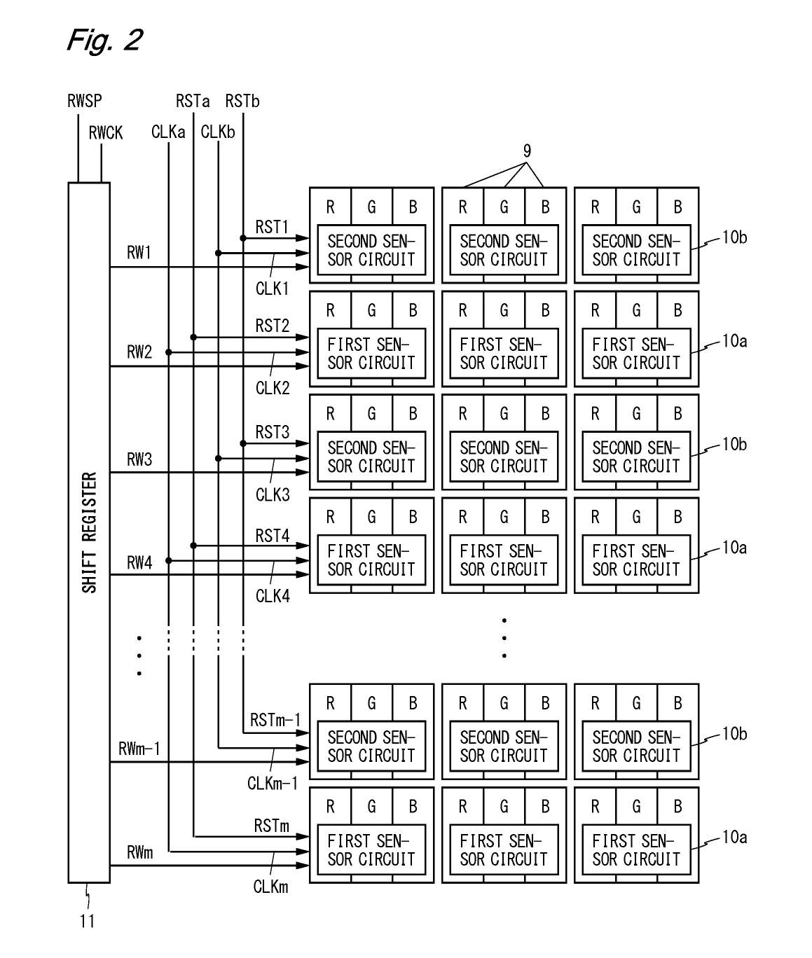

FIG. 2 is a diagram showing an arrangement of the sensor circuits 10 and a configuration of the sensor row driver circuit 7. As shown in FIG. 2, the (m×n) sensor circuits 10 are classified into a first sensor circuit 10a sensing light incident in a period in which the backlight 3 is turned off, and a second sensor circuit 10b sensing light incident in a period in which the backlight 3 is turned on. The number of first sensor circuits 10a is equal to the number of second sensor circuits 10b. The (m×n/2) first sensor circuits 10a are arranged in the even-numbered row, and the (m×n/2) second sensor circuits 10b are arranged in the odd-numbered row.

Each of the odd-numbered control lines CLK1, CLK3, . . . is connected to the control line CLKb. Each of the even-numbered control lines CLK2, CLK4, . . . is connected to the control line CLKa. Each of the odd-numbered reset lines RST1, RST3, . . . is connected to the reset line RSTb. Each of the even-numbered reset lines RST2, RST4, . . . is connected to the reset line RSTa. The first sensor circuit 10a is connected to the control line CLKa through the even-numbered control line, and is connected to the reset line RSTa through the even-numbered reset line. The second sensor circuit 10b is connected to the control line CLKb through the odd-numbered control line, and is connected to the reset line RSTb through the odd-numbered reset line.

The sensor row driver circuit 7 includes a shift register 11 provided with m stages. The shift register 11 sequentially shifts a pulse signal RWSP input to the first stage, based on a clock signal RWCK. The signals to be output from the respective stages of the shift register 11 sequentially turn to the HIGH level. Them signals output from the shift register 11 are fed to the read lines RW1 to RWm, respectively.

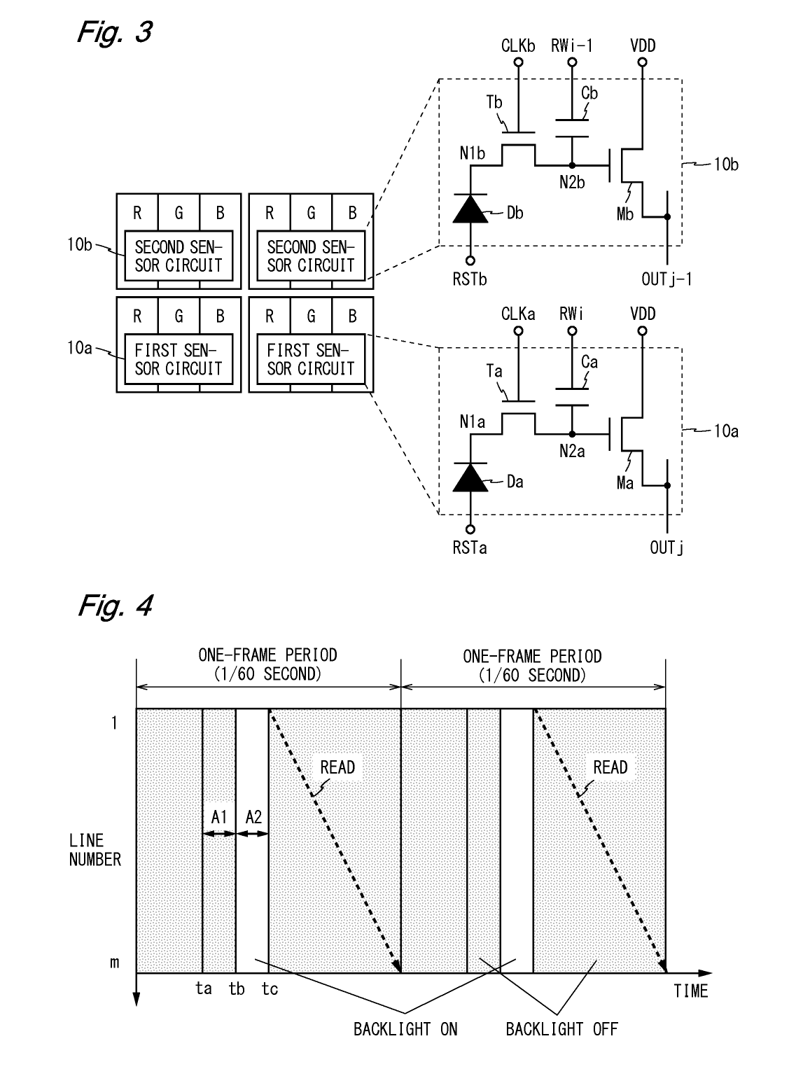

FIG. 3 is a circuit diagram of the sensor circuit 10. As shown in FIG. 3, the first sensor circuit 10a includes TFTs (Thin Film Transistors) Ta and Ma, a photodiode Da, and a capacitor Ca. The second sensor circuit 10b includes TFTs Tb and Mb, a photodiode Db, and a capacitor Cb. Each of the TFTs Ta, Ma, Tb and Mb is an N-channel type TFT. The photodiodes Da and Db function as an optical sensor, the TFTs Ta and Tb function as a charge retention transistor, and the TFTs Ma and Mb function as a read transistor.

In the first sensor circuit 10a, as for the photodiode Da, an anode is connected to a reset terminal, and a cathode is connected to a source of the TFT Ta. As for the TFT Ta, a gate is connected to a control terminal, and a drain is connected to a gate of the TFT Ma. As for the TFT Ma, a drain is connected to a power supply terminal, and a source is connected to an output terminal. The capacitor Ca is provided between the gate of the TFT Ma and a read terminal. Hereinafter, a node where the photodiode Da and the TFT Ta are connected is referred to as a node N1a, and a node where the TFT Ta, the TFT Ma and the capacitor Ca are connected is referred to as a node N2a. The node N2a functions as an accumulation node accumulating a charge corresponding to an amount of sensed light.

As for the first sensor circuit 10a, the control terminal is connected to the control line CLKa through the even-numbered control line. The reset terminal is connected to the reset line RSTa through the even-numbered reset line. The read terminal is connected to the even-numbered read line RWi. The output terminal is connected to the even-numbered output line OUTj. The power supply terminal is connected to the power supply line VDD.

The second sensor circuit 10b has the same configuration as that of the first sensor circuit 10a. As for the second sensor circuit 10b, however, the control terminal is connected to the control line CLKb through the odd-numbered control line. The reset terminal is connected to the reset line RSTb through the odd-numbered reset line. The read terminal is connected to the odd-numbered read line RWi-1. The output terminal is connected to the odd-numbered output line OUTj-1.

FIG. 4 is a diagram showing turn-on and turn-off timings of the backlight 3 as well as reset and read timings for the sensor circuit 10. The backlight 3 is turned on once for a predetermined time in a one-frame period, and is turned off in the remaining period. In the one-frame period, specifically, the backlight 3 is turned on at a time tb, and is turned off at a time tc. As described above, the backlight 3 is turned on and off at every predetermined cycle.

The first sensor circuit 10a senses light incident in the first sensing period A1 from a time ta to the time tb (the sensing period when the backlight 3 is turned off). The second sensor circuit 10b senses light incident in the second sensing period A2 from the time tb to the time tc (the sensing period when the backlight 3 is turned on). The length of the first sensing period A1 is equal to the length of the second sensing period A2. Reset for the first sensor circuit 10a is continuously performed in the period other than the first sensing period A1, and reset for the second sensor circuit 10b is continuously performed in the period other than the second sensing period A2. Read from the first sensor circuit 10a and read from the second sensor circuit 10b are performed in a line sequential manner in parallel after the time tc.

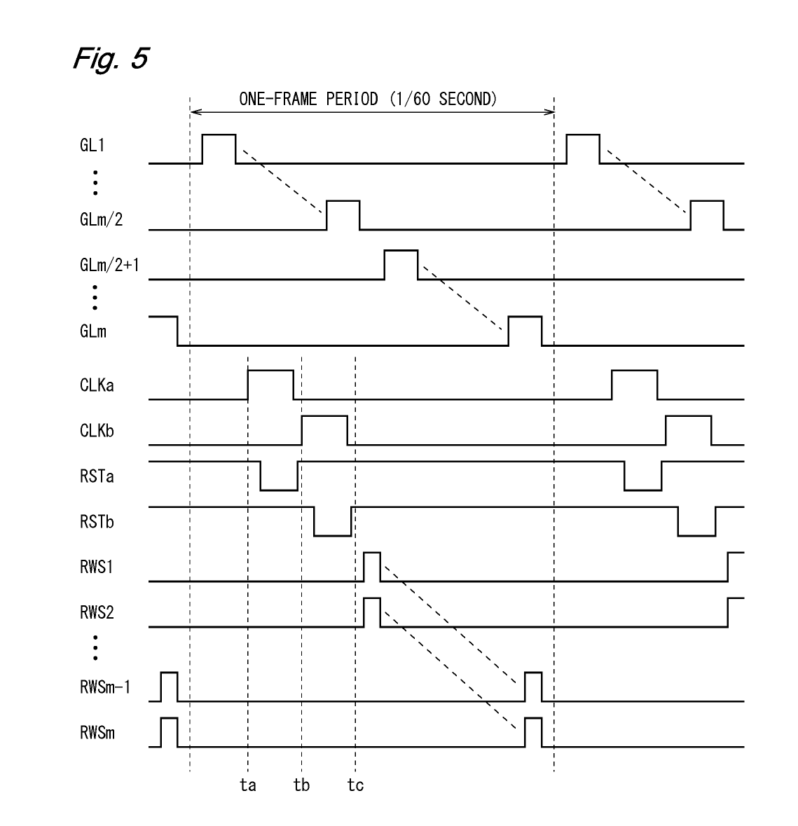

FIG. 5 is a signal waveform diagram of the display panel 2. Hereinafter, the same designation as that of the signal line is used for identification of a signal on the signal line (for example, the signal on the control line CLKa is referred to as the control signal CLKa). As shown in FIG. 5, the gate signals GL1 to GLm sequentially turn to the HIGH level once in the one-frame period for a predetermined time. The control signal CLKa turns to the HIGH level once in the one-frame period, in the first sensing period A1 (more specifically, from the time ta to a time point slightly before the time tb), and turns to the LOW level in the remaining period. The control signal CLKb turns to the HIGH level once in the one-frame period, in the second sensing period A2 (more specifically, from the time tb to a time point slightly before the time tc), and turns to the LOW level in the remaining period. The reset signal RSTa turns to the LOW level in the first sensing period A1 (more specifically, from a time point slightly after the time ta to a time point slightly before the time tb), and turns to the HIGH level in the remaining period. The reset signal RSTb turns to the LOW level in the second sensing period A2 (more specifically, from a time point slightly after the time tb to a time point slightly before the time tc), and turns to the HIGH level in the remaining period. The read signals RW1 to RWm are provided in pairs, and the (m/2) pairs of read signals sequentially turn to the HIGH level for a predetermined time after the time tc.

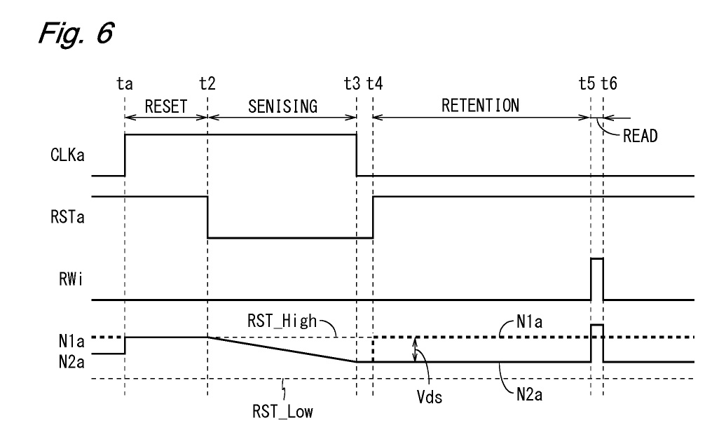

FIG. 6 is a signal waveform diagram of the first sensor circuit 10a. FIG. 6 shows changes in voltage at the nodes N1a and N2a. In FIG. 6, a reset period corresponds to a range from the time ta to a time t2, a sensing period corresponds to a range from the time t2 to a time t3, a retention period corresponds to a range from a time t4 to a time t5, and a read period corresponds to a range from the time t5 to a time t6. The control signal CLKa turns to the HIGH level in the reset period and the sensing period, and turns to the LOW level in the remaining period. The reset signal RSTa turns to the LOW level in the sensing period and a period from the time t3 to the time t4, and turns to the HIGH level in the remaining period. The read signal RWi turns to the HIGH level in the read period, and turns to the LOW level in the remaining period.

In the reset period (from the time ta to the time t2), the control signal CLKa and the reset signal RSTa turn to the HIGH level, and the read signal RWi turns to the LOW level. Herein, the TFT Ta is in an ON state. Accordingly, a current (a forward current of the photodiode Da) flows from the reset line RSTa into the node N2a via the photodiode Da and the TFT Ta, and a voltage at the node N2a is reset to the HIGH level.

In the sensing period (from the time t2 to the time t3), the control signal CLKa remains at the HIGH level, the read signal RWi remains at the LOW level, and the reset signal RSTa turns to the LOW level. In the sensing period, the TFT Ta is still in the ON state. Therefore, when light is incident on the photodiode Da, a current (a photocurrent of the photodiode Da) flows from the node N2a to the reset line RSTa via the TFT Ta and the photodiode Da, and a charge is drawn from the node N2a. Accordingly, a voltage at the node N2a falls corresponding to an amount of light incident in the sensing period (the sensing period when the backlight 3 is turned off). In the reset period and the sensing period, since the TFT Ta is in the ON state, a voltage at the node N1a is equal to the voltage at the node N2a.

At the time t3, the control signal CLKa turns to the LOW level. After the time t3, the TFT Ta turns to an OFF state, and the nodes N1a and N2a are electrically disconnected from each other.

In the retention period (from the time t4 to the time t5), the control signal CLKa and the read signal RWi remain at the LOW level, and the reset signal RSTa turns to the HIGH level. In the retention period, the TFT Ta is in the OFF state, and the nodes N1a and N2a are electrically disconnected from each other. Therefore, even when light is incident on the photodiode Da, the voltage at the node N2a does not change. On the other hand, the voltage at the node N1a is reset to the HIGH level (see a bold broken line in FIG. 6). In the retention period, a drain-source voltage Vds of the TFT Ta corresponds to a difference between the voltage at the node N1a and the voltage at the node N2a.

In the read period (from the time t5 to the time t6), the control signal CLKa remains at the LOW level, the reset signal RSTa remains at the HIGH level, and the read signal RWi turns to the HIGH level. In the read period, the TFT Ta is still in the OFF state. Herein, the voltage at the node N2a rises by predetermined times as large as a rise amount of a voltage of the read signal RWi (the multiplier is determined by a ratio between a capacitance value of the capacitor Ca and a capacitance value of the entire first sensor circuits 10a). The TFT Ma constitutes a source follower amplification circuit using, as a load, a transistor (not shown) included in the sensor column driver circuit 8, and drives the output line OUTa corresponding to the voltage at the node N2a.

As described above, the first sensor circuit 10a outputs a signal corresponding to an amount of light incident in the first sensing period A1 (the sensing period when the backlight 3 is turned off). The second sensor circuit 10b operates in the similar manner to the first sensor circuit 10a, and outputs a signal corresponding to an amount of light incident in the second sensing period A2 (the sensing period when the backlight 3 is turned on). Accordingly, by obtaining the difference between the output signal from the first sensor circuit 10a and the output signal from the second sensor circuit 10b by using the difference circuit included in the sensor column driver circuit 8, it is possible to obtain the difference between the amount of light when the backlight is turned on and the amount of light when the backlight is turned off.

The display device according to this embodiment applies the retention voltage for lowering the drain-source voltage Vds of each of the TFTs Ta and Tb to the reset lines RSTa and RSTb during the period that the TFTs Ta and Tb are controlled to be in the OFF state (i.e., in the period other than the sensing period). The display device according to this embodiment applies, as the retention voltage, the HIGH-level voltage (the reset voltage) to the reset line RST in the period other than the sensing period. In comparison with a display device that applies the LOW-level voltage (the reset cancellation voltage) to the reset line RST in the period other than the sensing period (hereinafter, referred to as a display device according to a reference example), effects of the display device according to this embodiment will be described hereinafter.

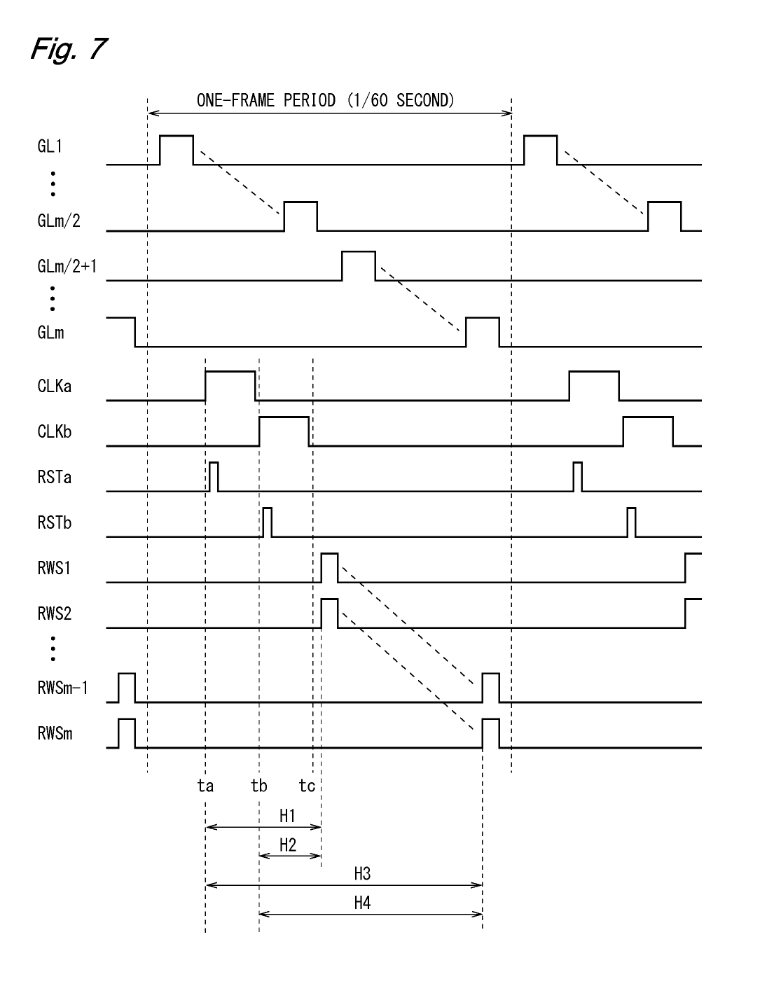

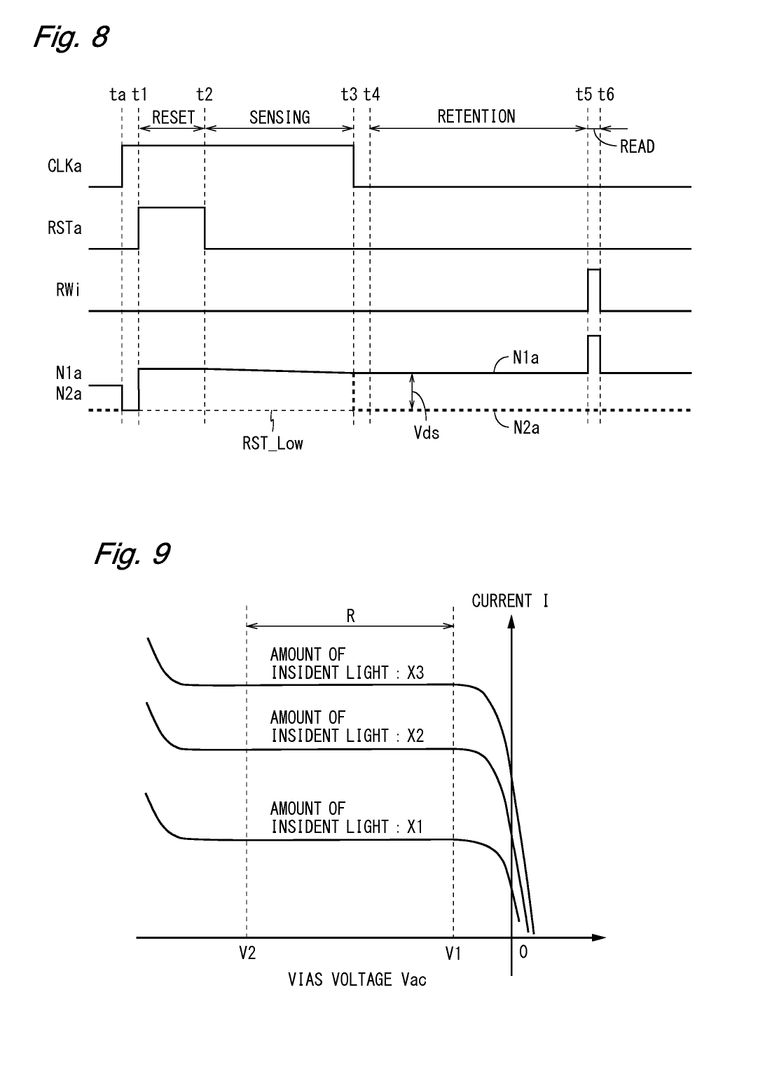

FIGS. 7 and 8 are signal waveform diagrams of the display device according to the reference example. In the display device according to the reference example, as shown in FIG. 7, the reset signal RSTa turns to the HIGH level in a part of the first sensing period (more specifically, for a predetermined time from a time point slightly after the time ta), and turns to the LOW level in the remaining period. The reset signal RSTb turns to the HIGH level in a part of the second sensing period A2 (more specifically, for a predetermined time from a time point slightly after the time tb), and turns to the LOW level in the remaining period. As shown in FIG. 8, the reset signal RSTa turns to the HIGH level only in the reset period (from the time t1 to the time t2).

FIG. 9 is a diagram showing an I-V characteristic of the photodiode. FIG. 9 shows the I-V characteristic in a case of changing an amount of incident light in three steps between X1 and X3 (X1<X2<X3). In FIG. 9, a horizontal axis indicates a bias voltage Vac applied to the photodiode, and a vertical axis indicates an absolute value of a current I flowing through the photodiode. When a negative bias voltage Vac is applied, a reverse current flows through the photodiode. When the bias voltage Vac falls within a range R (a range from V2 to V1) shown in FIG. 9, the reverse current remains almost constant. It is preferable to use the photodiode under conditions that the current does not change even when the bias voltage Vac changes, and the current changes in a linear manner when the amount of incident light changes. Therefore, in the case of using the photodiode having the I-V characteristic shown in FIG. 9, the bias voltage Vac falling within the range R is applied. The values of the voltages V1 and V2 vary depending on a fabrication process and a device structure.

In the case where the HIGH-level voltage is the reset voltage in the first sensor circuit 10a shown in FIG. 3, the LOW-level voltage of the reset signal RSTa is determined such that the absolute value |Vac| of the bias voltage immediately after the reset becomes |V2| or less (Vac>V2). In the sensing period, the voltage at the node N2a falls gradually, and the absolute value |Vac| of the bias voltage decreases gradually. In order to make the photodiode operate correctly, when maximum light is incident on the photodiode in the sensing period, the length of the sensing period, and the like are determined such that the absolute value |Vac| of the bias voltage at the end of the sensing period becomes ↑V1| or more (Vac<V1).

Specific examples will be described below. In the following, consideration is given to a case where the LOW-level voltage of the reset signal is set to −5 V, the HIGH-level voltage of the reset signal is set to 0 V and the bias voltage Vac in a range from −5 V or more to −2 V or less is applied to the photodiode. In this case, the voltage at the node N1a changes within a range from −5 V to 0 V, and the voltage at the node N2a changes within a range from −3 V to 0 V.

In the display device according to the reference example, under the foregoing conditions (RST=−5 V/0 V, Vac=−5 V to −2 V), the leakage current flowing through the TFT Ta becomes maximum when the voltage at the node N1a is −5 V and the voltage at the node N2a is 0 V. Herein, the absolute value |Vds| of the drain-source voltage of the TFT Ta becomes 5 V. Accordingly, the leakage current corresponding to |Vds|=5 V flows through the TFTs Ta and Tb. Therefore, in the display device according to the reference example, noise due to the leakage current corresponding to 5 V is mixed into the output from the sensor circuit, so that a light detection accuracy is degraded accordingly.

In the signal waveform diagram shown in FIG. 7, the sensing by the first sensor circuit 10a and the sensing by the second sensor circuit 10b are performed in the different periods. Moreover, since the read from the sensor circuit 10 is performed in the line sequential manner, the length of the retention period differs for each of the sensor circuit 10 subjected to the read at first and the sensor circuit 10 subjected to the read at last. Therefore, when the retention period of the first sensor circuit 10a subjected to the read at first is denoted with H1, the retention period of the second sensor circuit 10b subjected to the read at first is denoted with H2, the retention period of the first sensor circuit 10a subjected to the read at last is denoted with H3, and the retention period of the second sensor circuit 10b subjected to the read at last is denoted with H4, all the four retention periods are different in length from one another. As described above, in the case where the length of the retention period differs for each of the sensor circuits, the outputs from the sensor circuits vary because of the difference in length of the retention periods, depending on the leakage current flowing through the TFTs Ta and Tb, and the light detection accuracy is degraded.

The display device according to this embodiment applies the HIGH-level voltage to the reset line RST as the retention voltage for lowering the drain-source voltage Vds of the TFT Ta during the period that the TFT Ta is controlled to be in the OFF state. Therefore, under the foregoing conditions (RST=−5 V/0 V, Vac=−5 V to −2 V), the leakage current flowing through the TFT Ta becomes maximum when the voltage at the node N1a is 0 V and the voltage at the node N2a is −3 V. Herein, the absolute value |Vds| of the drain-source voltage of the TFT Ta becomes 3V. This value is smaller than that of the display device according to the reference example. Accordingly, in the display device according to this embodiment, it is possible to reduce the leakage current flowing through the TFT Ta, and to enhance the light detection accuracy, by applying the HIGH-level voltage as the retention voltage to the reset line RST during the period that the TFT Ta is controlled to be in the OFF state.

As described above, the display device according to this embodiment applies, to the reset lines RSTa and RSTb, the retention voltage for lowering the voltage between the conductive terminals of the charge retention transistor (between the drain and the source of the TFTs Ta and Tb) when the charge retention transistor (the TFTs Ta and Tb) is in the OFF state. Thus, it is possible to lower the voltage between the conductive terminals of the charge retention transistor, and to reduce the leakage current flowing through the charge retention transistor. Accordingly, it is possible to accumulate a charge corresponding to an amount of sensed light in the accumulation node with high accuracy, and to enhance the detection accuracy by the optical sensor. By using the reset voltage (the HIGH-level voltage) as the retention voltage, particularly, it is possible to lower the voltage between the conductive terminals of the charge retention transistor, and to reduce the leakage current flowing through the charge retention transistor, without generating a new voltage. Accordingly, it is possible to enhance the detection accuracy by the optical sensor with simple circuitry.

Moreover, it is possible to individually sense the amount of light when the light source (the backlight 3) is turned off and the amount of light when the light source is turned on, by using the two types of sensor circuits 10a and 10b, and to obtain the difference between the two amounts at the outside of the sensor circuits 10a and 10b. Thus, it is possible to provide an input function which does not depend on a light environment, by using the light emitted from the light source as signal light. Moreover, it is possible to increase the degree of freedom at the determination of the sensing and read timings, by performing the sensing and the read for the two types of sensor circuits 10a and 10b in the different periods. Moreover, it is possible to make a read speed slower, and to reduce a power consumption of the display device, by performing the read from the first sensor circuit 10a and the read from the second sensor circuit 10b in parallel.

Moreover, it is possible to constitute the sensor circuit sensing only light incident in the predetermined period, by connecting the optical sensor (the photodiode Da) and the charge retention transistor (the TFT Ta) in series, connecting one end thereof to the reset line RSTa, and connecting the other end to the accumulation node (the node N2a). Moreover, it is possible to output the signal corresponding to the voltage at the accumulation node from one of the conductive terminals (the source terminal) of the read transistor, and to read the signal corresponding to the amount of sensed light from the sensor circuit, by providing the read transistor (the TFT Ma) in the sensor circuit, and applying the power supply voltage VDD to the other conductive terminal (the drain terminal) of the read transistor. Moreover, it is possible to change the voltage at the accumulation node, and to read the signal corresponding to the amount of sensed light from the sensor circuit, by providing the capacitor (the capacitor Ca) in the sensor circuit, and applying the read voltage (the HIGH-level voltage) to the read line RWi.

### Second Embodiment

A display device according to a second embodiment of the present invention has the same configuration as that of the display device according to the first embodiment, and includes the same pixel circuit as that of the display device according to the first embodiment (see FIGS. 1 and 3). This embodiment is different from the first embodiment in the level of a retention voltage to be applied to a reset line. Hereinafter, differences from the first embodiment will be described.

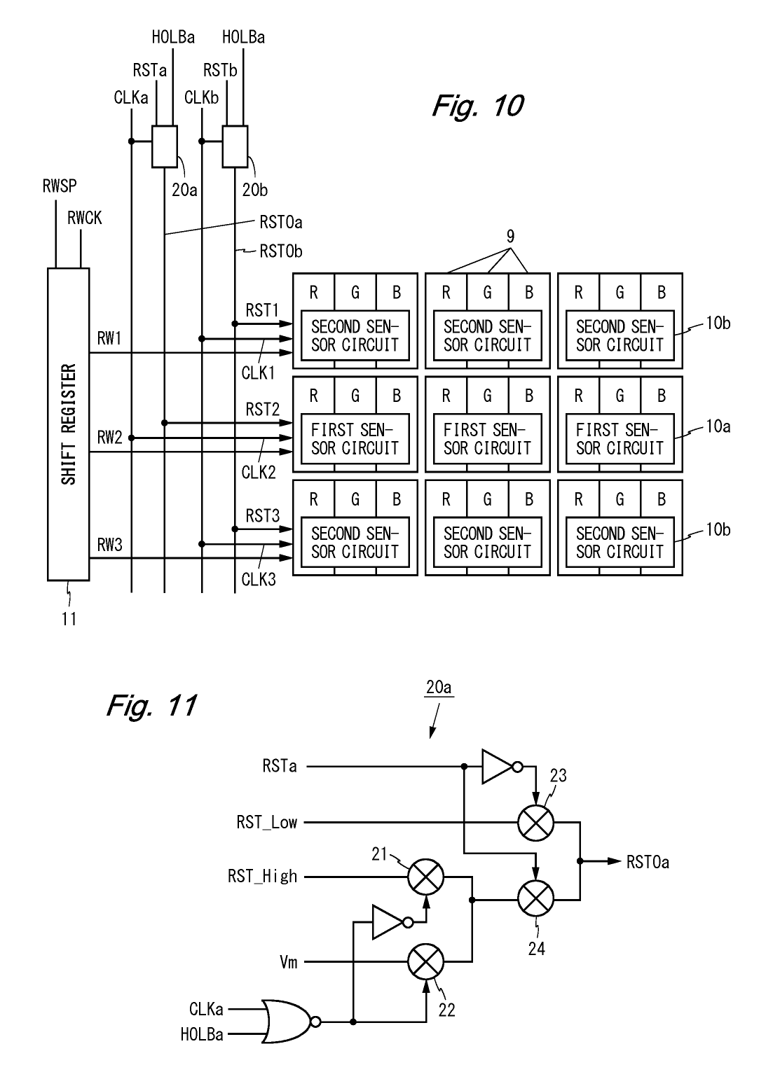

FIG. 10 is a diagram showing an arrangement of sensor circuits 10 and a configuration of a sensor row driver circuit 7, in the display device according to this embodiment. In this embodiment, each of odd-numbered reset lines RST1, RST3, . . . is connected to a reset line RSTOb. Each of even-numbered reset lines RST2, RST4, . . . is connected to a reset line RSTOa. The sensor row driver circuit 7 includes a reset control circuit 20a outputting a reset signal RSTOa, and a reset control circuit 20b outputting a reset line RSTOb.

FIG. 11 is a circuit diagram of the reset control circuit 20a. As shown in FIG. 11, the reset control circuit 20a includes four analog switches 21 to 24. Control signals CLKa and HOLBa, a reset signal RSTa, a HIGH-level voltage RST_High, a LOW-level voltage RST_Low and an intermediate voltage Vm are input to the reset control circuit 20a. When the reset signal RSTa is in a LOW level, the analog switch 23 turns to an ON state, the analog switch 24 turns to an OFF state, and a voltage of the reset signal RSTa becomes equal to the LOW-level voltage RST_Low. When the reset signal RSTa is in a HIGH level and at least one of the control signals CLKa and HOLBa is in the HIGH level, the analog switches 21 and 24 turn to the ON state, the analog switches 22 and 23 turn to the OFF state, and a voltage of the reset signal RSTOa becomes equal to the HIGH-level voltage RST_High. When the reset signal RSTa is in the HIGH level and both of the control signals CLKa and HOLBa are in the LOW level, the analog switches 22 and 24 turn to the ON state, the analog switches 21 and 23 turn to the OFF state, and the voltage of the reset signal RSTOa becomes equal to the intermediate voltage Vm. The reset control circuit 20b has the same configuration as that of the reset control circuit 20a.

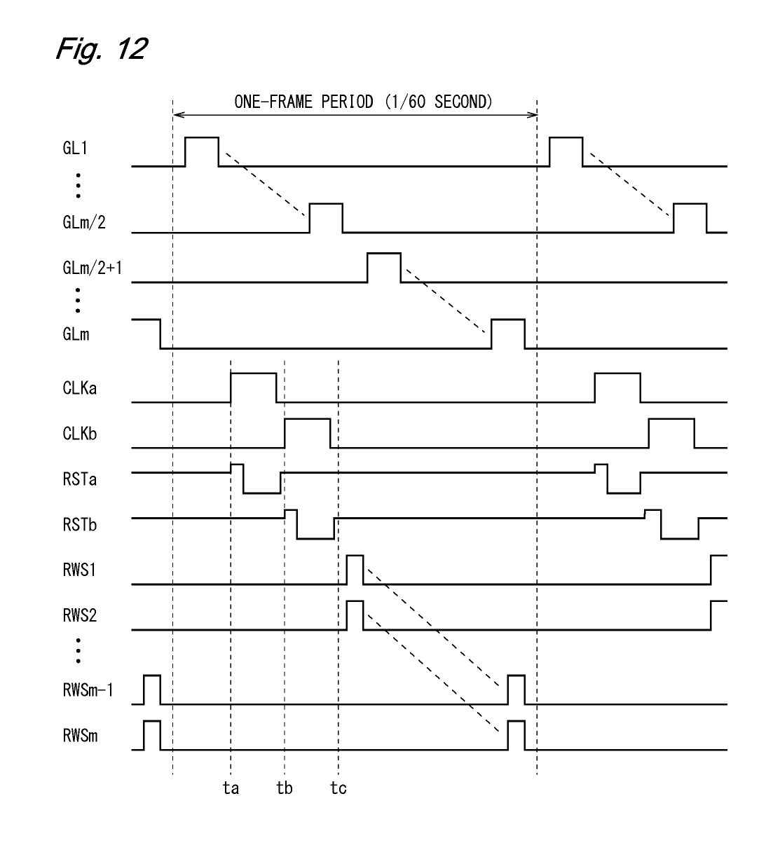

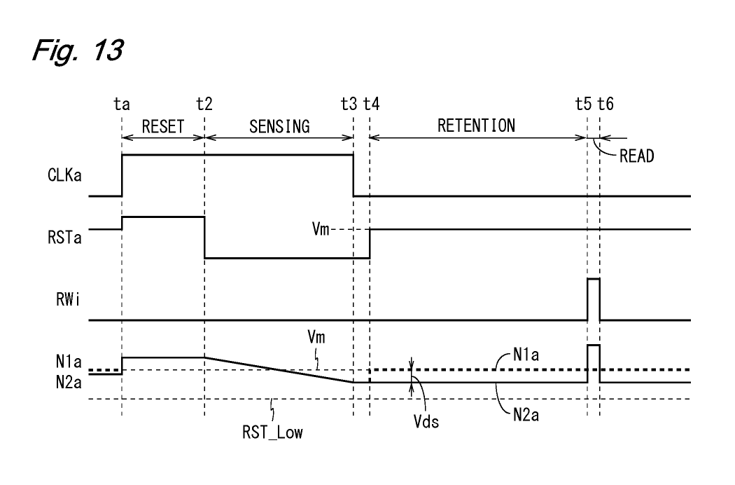

FIGS. 12 and 13 are signal waveform diagrams of the display device according to this embodiment. In the display device according to this embodiment, as shown in FIG. 12, the reset signal RSTa turns to the HIGH level in a leading portion of a first sensing period (more specifically, for a predetermined time from a time ta), turns to the LOW level in the remaining portion of the first sensing period (more specifically, from a time point after a lapse of the predetermined time from the time ta to a time point slightly before a time tb), and turns to an intermediate level (the intermediate voltage Vm) in the remaining period. The reset signal RSTb turns to the HIGH level in a leading portion of a second sensing period (more specifically, for a predetermined time from the time tb), turns to the LOW level in the remaining portion of the second sensing period (more specifically, from a time point after a lapse of the predetermined time from the time tb to a time point slightly before a time tc), and turns to the intermediate level in the remaining period. As shown in FIG. 13, the reset signal RSTa turns to the HIGH level in a reset period (from the time ta to a time t2), turns to the LOW level in a sensing period (from the time t2 to a time t3) and a period from the time t3 to a time t4, and turns to the intermediate level in the remaining period.

A voltage between a reset voltage (a HIGH-level voltage) and a reset cancellation voltage (a LOW-level voltage) is used as the intermediate voltage Vm. For example, a substantially middle voltage between the HIGH-level voltage and a voltage at a node N2a at the sensing of a maximum amount of light can be used as the intermediate voltage Vm. Under the foregoing conditions (RST=−5 V/0 V, Vac=−5 V to −2 V), the voltage at the node N2a at the sensing of the maximum amount of light becomes −3 V. In this case, a voltage of −1.5 V which is an middle voltage between 0 V (the HIGH-level voltage) and −3 V (or, a voltage which is substantially equal to −1.5 V) can be used as the intermediate voltage Vm.

In the case of setting the intermediate voltage Vm to −1.5 V under the foregoing conditions, a leakage current flowing through a TFT Ta becomes maximum when a voltage at a node N1a is −1.5 V and the voltage at the node N2a is 0 V and when the voltage at the node N1a is −1.5 V and the voltage at the node N2a is −3 V. In any case, an absolute value |Vds| of a drain-source voltage of the TFT Ta becomes 1.5 V. This value is smaller than that of the display device according to the reference example and is also smaller than that of the display device according to the first embodiment. Accordingly, in the display device according to this embodiment, it is possible to further lower the drain-source voltage Vds of the TFT Ta, to further reduce the leakage current flowing through the TFT Ta, and to further enhance the light detection accuracy, by applying, as a retention voltage, the middle voltage between the HIGH-level voltage and the voltage at the accumulation node at the sensing of the maximum amount of light, to the reset line RST during the period that the TFT Ta is controlled to be in the OFF state.

As described above, in the display device according to this embodiment, by using, as the retention voltage, the voltage between the reset voltage (the HIGH-level voltage) and the reset cancellation voltage (the LOW-level voltage), it is possible to further lower the voltage between the conductive terminals of the charge retention transistor (the drain-source voltage of the TFTs Ma and Mb), and to further reduce the leakage current flowing through the charge retention transistor. Accordingly, it is possible to further enhance the detection accuracy by the optical sensor. Particularly, it is effective to use, as the retention voltage, the substantially middle voltage between the reset voltage and the voltage at the accumulation node at the sensing of the maximum amount of light.

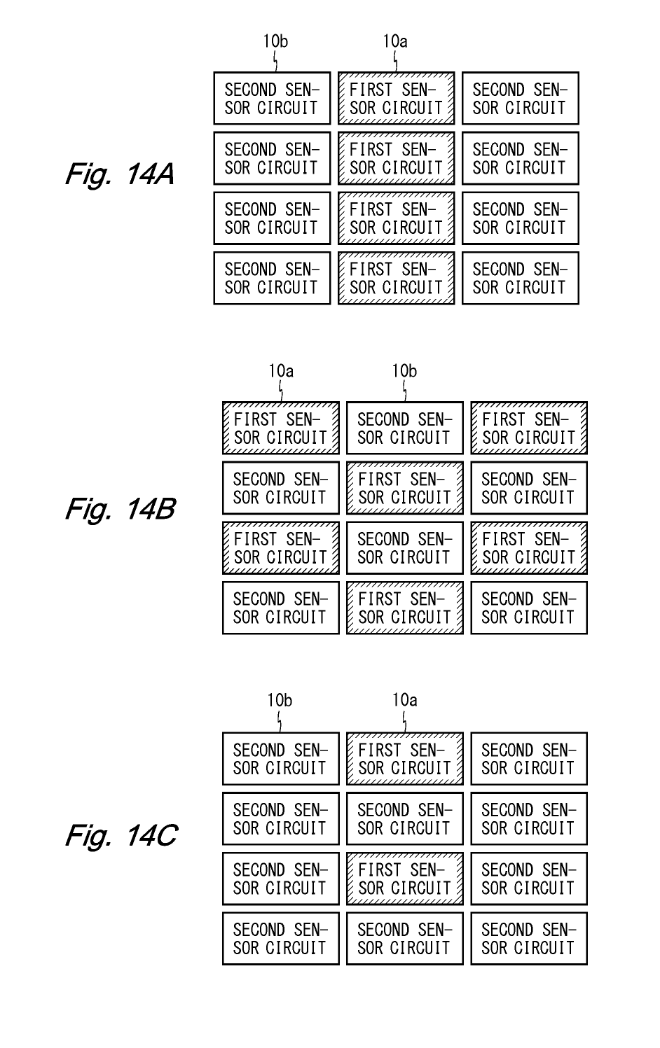

For the display device of the present invention, various modification examples can be configured. For example, the number of sensor circuits 10 and the number of read lines in the pixel region 4 may be arbitrary. For example, the (m×n) sensor circuits 10 in total may be arranged near the intersections between the m read lines and the n output lines, respectively. Alternatively, the sensor circuits 10 may be provided corresponding to a plurality of color pixels. Moreover, the arrangement form of the first sensor circuit 10a and the second sensor circuit 10b may be arbitrary. As shown in FIG. 14A, for example, two types of sensor circuits may be arranged and aligned in a longitudinal direction. As shown in FIG. 14B, alternatively, two types of sensor circuits may be arranged in a staggered manner. As shown in FIG. 14C, alternatively, two types of sensor circuits may be different in number from each other.

Moreover, the display device of the present invention may firstly perform the sensing by the first sensor circuit 10a, or may firstly perform the sensing by the second sensor circuit 10b. Moreover, the display device of the present invention may perform the read from the sensor circuit every single row or every plural rows. In the case of performing the read from the sensor circuit every plural rows, however, it is necessary to provide a large number of output lines for outputting simultaneously read signals to the outside of the pixel region 4. Moreover, the display device of the present invention may perform the sensing by the two types of sensor circuits and the read from the respective sensor circuits by two or more times in a one-frame period.

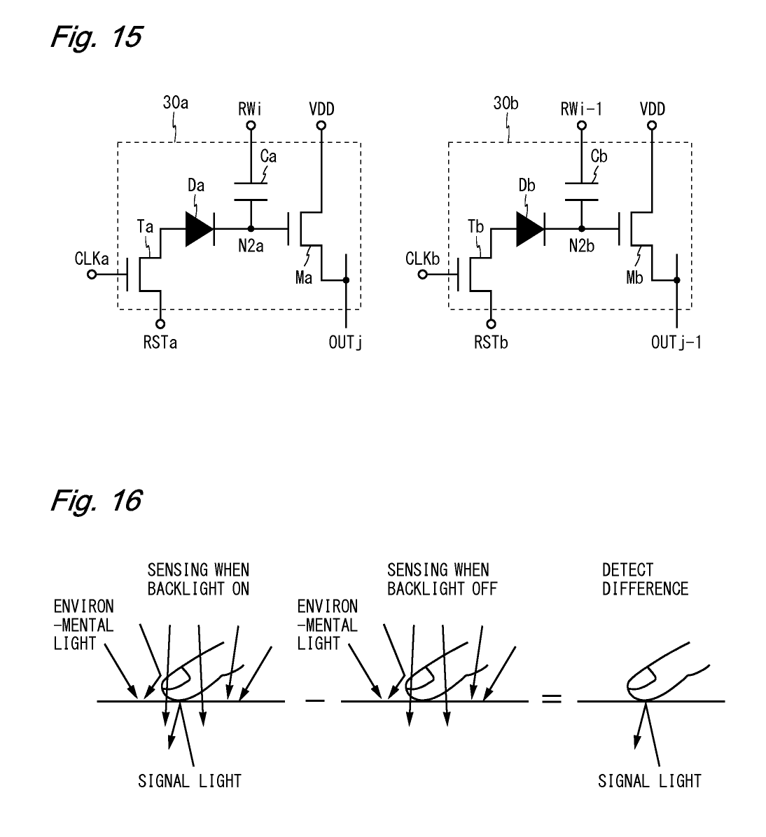

Moreover, the display device of the present invention may include a sensor circuit 30 shown in FIG. 15 in place of the sensor circuit 10 shown in FIG. 3. The first sensor circuit 30a is different from the first sensor circuit 10a in a point that the TFT Ta and the photodiode Da are connected in reverse order. In the first sensor circuit 30a, as for the TFT Ta, the source is connected to the reset terminal, and the drain is connected to the anode of the photodiode Da. The cathode of the photodiode Da is connected to the gate of the TFT Ma. The second sensor circuit 30b has the same configuration as that of the first sensor circuit 30a. The sensor circuits 30a and 30b operate as in the sensor circuits 10a and 10b.

Moreover, the display device of the present invention is not limited to that including two types of sensor circuits. The display device of the present invention may include one type of sensor circuits, or may include three or more types of sensor circuits. The present invention is applicable to various display devices such as a liquid crystal display device including a liquid crystal panel in which a plurality of optical sensors are arranged in a two-dimensional manner. The display devices according to these modification examples attain similar effects to those of the display devices according to the first and second embodiments.

### INDUSTRIAL APPLICABILITY

The display device of the present invention has the features in that a leakage current flowing through the charge retention transistor is small and the light detection accuracy is high and, therefore, can be used as various display devices such as a liquid crystal display device.

### DESCRIPTION OF REFERENCE CHARACTERS

1: Display control circuit
2: Display panel
3: Backlight
4: Pixel region
5: Gate driver circuit
6: Source driver circuit
7: Sensor row driver circuit
8: Sensor column driver circuit
9: Pixel circuit
10, 30: Sensor circuit
11: Shift register
20: Reset control circuit
21 to 24: Analog switch

1. A display device in which a plurality of optical sensors are arranged in a pixel region, the display device comprising:
a display panel including a plurality of pixel circuits and a plurality of sensor circuits; and
a drive circuit driving the pixel circuit and the sensor circuit, wherein
the sensor circuit includes:
an accumulation node accumulating a charge corresponding to an amount of sensed light;
an optical sensor provided between the accumulation node and a reset line to be controlled by the drive circuit; and
a charge retention transistor provided in series with the optical sensor and subjected to ON/OFF control by the drive circuit, and
the drive circuit applies, to the reset line, a retention voltage for lowering a voltage between conductive terminals of the charge retention transistor, during a period that the charge retention transistor is controlled to be in an OFF state.

2. The display device according to claim 1, wherein
the drive circuit applies a reset voltage as the retention voltage to the reset line.

3. The display device according to claim 1, wherein
the drive circuit applies a voltage between a reset voltage and a reset cancellation voltage, as the retention voltage to the reset line.

4. The display device according to claim 3, wherein
the drive circuit applies a substantially middle voltage between the reset voltage and a voltage at the accumulation node at the sensing of a maximum amount of light, as the retention voltage to the reset line.

5. The display device according to claim 1, further comprising:
a light source to be turned on and off at a predetermined cycle, wherein
the sensor circuits include a first sensor circuit and a second sensor circuit, and
the drive circuit controls the charge retention transistor in the first sensor circuit to be in an ON state during a period that light source is turned off, and controls the charge retention transistor in the second sensor circuit to be in the ON state during a period that the light source is turned on.

6. The display device according to claim 5, wherein
the drive circuit performs read from the first and second sensor circuits in a line sequential manner while controlling all the charge retention transistors in the first and second sensor circuits to be in an OFF state.

7. The display device according to claim 6, wherein
the drive circuit performs the read from the first sensor circuit and the read from the second sensor circuit in parallel.

8. The display device according to claim 1, wherein
one end of the optical sensor is connected to the reset line, the other end is connected to one of the conductive terminals of the charge retention transistor, and the other conductive terminal of the charge retention transistor is connected to the accumulation node.

9. The display device according to claim 8, wherein
the sensor circuit further includes a read transistor having a control terminal connected to the accumulation node.

10. The display device according to claim 9, wherein
the sensor circuit further includes a capacitor provided between the accumulation node and a read line to be controlled by the drive circuit.
